(19) United States
(12) Patent Application Publication
(10) Pub. No.: US 2025/0285406 A1
(43) Pub. Date: Sep. 11, 2025

(54) METHOD TO EXTRACT COLOR AND TEXTURE INFORMATION FROM ROCK PARTICLE INSTANCE IMAGES

(71) Applicant: Schlumberger Technology Corporation, Sugar Land, TX (US)

(72) Inventors: Tetsushi Yamada, Cambridge, MA (US); Simone Di Santo, Dhahran (SA); Karim Bondabou, Montpellier (FR)

(21) Appl. No.: 18/888,739

(22) Filed: Sep. 18, 2024

Related U.S. Application Data
(60) Provisional application No. 63/562,275, filed on Mar. 7, 2024.

(51) Int. Cl. G06V 10/44; G06V 10/54; G06V 10/56; G06V 10/771

(52) U.S. Cl. CPC G06V 10/44; G06V 10/54; G06V 10/56; G06V 10/771

(57) ABSTRACT

Systems and methods are provided to extract features (e.g., colors, textual features) from arbitrary shaped and sized images by implementing global average pooling (GAP) and partial convolution in an autoencoder (AE) for analysis of the images. A global average pooling (GAP) layer may be used at the last layer of the encoder of the AE to make the feature rotation and translation invariant and scale equivariant. In addition, partial convolution may be used in the encoder to logically ignore the invalid pixels (e.g., background, image error, other object) or any pixel (e.g., in any area) in the images.

### CROSS-REFERENCE TO RELATED APPLICATIONS

This application claims priority to U.S. Provisional Application No. 63/562,275, filed Mar. 7, 2024, which is incorporated by reference herein in its entirety.

### BACKGROUND

The present disclosure generally relates to systems and methods for extracting color and texture information from rock particle instance images, and, more specifically, to the integration of global average pooling (GAP) and partial convolution in an autoencoder (AE) for analysis of the images of the rock particles.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Rock particles are usually a fundamental unit of domain-specific post-processing analysis that has been widely used in industry and scientific applications, including, but not limited to, space exploration, mining, civil engineering, geothermal, and oil and gas. Image data of the rock particles typically come from imaging systems that produce digital images or three-dimensional (3D) images from a laser scanner. Once rock particles are detected and segmented, they may be used to compute the rock particle properties such as size, shapes, textures, and other morphological, rock properties and petrophysical properties to answer domain-specific questions.

In oil and gas, geothermal, as well as scientific exploration applications, rock particles are produced during drilling activities. The rock particles are called rock cuttings (or caving's, depending on their sizes). Rock cuttings are generally used to identify lithology types for the subsurface characterization and are one of the highest available and lowest cost data sources for understanding and characterizing the subsurface rock properties. As such, there is a strong industry need to automatically analyze rock cuttings to extract rock particle properties (e.g., features), thereby reducing human cost, improving the accuracy and efficiency of the analysis process, and shortening the turnaround time of the interpretation. In particular, existing feature extraction techniques may be limited on extracting texture features from rock cutting instance images due to the properties of texture, such as spatial information captured in the features, feature size depending on input size, shape similarity affected by the existence of background, blurry reconstructed image caused by the pixel-based reconstruction loss, and the like. For example, rock cutting instances may have arbitrary shapes and sizes, which may introduce background pixels in the rock cutting instance images during image acquisition, and these background pixels may be excluded from the feature extraction process. Further, some portion of the rock cutting instance images may contain pixels that do not represent any feature of the rock particles (e.g., imaging errors, other objects), and these pixels may be excluded from the feature extraction process. These pixels do not represent any feature of the rock particles and are counted as invalid pixels when extracting features from the rock cutting instance images. Accordingly, it is desirable to automatically analyze rock cuttings to extract color and texture information from arbitrary shaped and sized rock particle instance images containing invalid pixels. It should be noted that, in some embodiments, the system and methods described herein may be used for excluding any pixel (e.g., in any area of the input image) from the feature extraction process for imaging processing purposes, such as image inpainting, etc.

### SUMMARY

A summary of certain embodiments described herein is set forth below. It should be understood that these aspects are presented merely to provide the reader with a brief summary of these certain embodiments and that these aspects are not intended to limit the scope of this disclosure.

Implementations herein are directed to systems and methods to extract features (e.g., colors, textual features) from arbitrary shaped and sized images by implementing global average pooling (GAP) and partial convolution in an autoencoder (AE) for analysis of the images. It should be noted that, the feature extraction technique described herein may be applied to other images (e.g., rock core images, borehole images) and/or images in any domain, such as remote sensing and medical imaging. In some embodiments, an autoencoder (AE), which may be data driven and/or unsupervised, may be used to extract texture features from images. In some embodiments, a variational autoencoder (VAE) may be used to control the distribution of the latent space. In some embodiments, a vanilla AE may be used instead of VAE. A global average pooling (GAP) layer may be used at the last layer of the encoder to make the feature rotation and translation invariant and scale equivariant. In addition, partial convolution may be used in the encoder to logically ignore the invalid pixels (e.g., background, image error, other object) in the images. It should be noted that, in some embodiments, the system and methods described herein may be used for excluding any pixel (e.g., in any area of the input image) from the feature extraction process for imaging processing purposes, such as image inpainting, etc.

Certain embodiments of the present disclosure include a method that includes receiving, via an encoder, an image; generating, via the encoder, a feature map by performing a partial convolution operation using the image and a mask image for the image; generating, via the encoder, an updated mask image based on the mask image and a dimension of the feature map; performing, via the encoder, a global average pooling (GAP) operation on the feature map using the updated mask image to generate a global feature map; and generating, via the encoder, an output feature image for the cutting instance image based on the global feature map.

Certain embodiments of the present disclosure also include a method of training an autoencoder (AE) that includes generating a set of training images from a plurality of images; generating respective mask images for the set of training images; inputting the set of training images and the respective mask images into an encoder of the AE. And the encoder of the AE is configured to: generating respective feature maps for the set of training images by performing partial convolution operation using the training images and the respective mask images; and generating respective global feature maps by performing a global average pooling (GAP) operation on the respective feature maps. The method of training the AE also includes generating, via a decoder of the AE, respective output images for the set of training images based on the respective global feature maps; and training the AE using the respective output images and the training images based on a loss function.

Certain embodiments of the present disclosure also include an autoencoder (AE) that includes an encoder. The encoder includes a convolution layer configured to generated a feature map by performing a partial convolution operation using an image and a mask image for the image. The encoder also includes a global average pooling (GAP) layer configured to generate a global feature map by performing a GAP operation on the feature map using an updated mask image generated based on the mask image. The AE also includes a decoder configured to generate an output image based on the global feature map.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates a drilling system, in accordance with embodiments of the present disclosure;

FIG. 2 illustrates a shale shaker removing drill bit cuttings from drilling fluid, in accordance with embodiments of the present disclosure;

FIG. 3 illustrates a drill bit generating cuttings, in accordance with embodiments of the present disclosure;

FIG. 4 illustrates a system that includes an analysis and control system to monitor and control the drilling system of FIG. 1, in accordance with embodiments of the present disclosure;

FIG. 5 illustrates a cuttings collection and image acquisition workflow that may be performed by the analysis and control system of FIG. 4, in accordance with embodiments of the present disclosure;

FIG. 6 illustrates an example workflow for lithological characterization of cuttings based on analysis of images of the cuttings, in accordance with embodiments of the present disclosure;

FIG. 7 illustrates a rock sample image and the corresponding segmented individual cutting instance images, in accordance with embodiments of the present disclosure;

FIG. 8 illustrates other embodiment of the segmented individual cutting instance images of FIG. 7, in accordance with embodiments of the present disclosure;

FIG. 9 illustrates an example workflow for property estimation process of FIG. 6, in accordance with embodiments of the present disclosure;

FIG. 10 illustrates a process for implementing an encoder to transform the segmented individual cutting instance images having invalid pixels from the image space to the latent vector space, in accordance with embodiments of the present disclosure;

FIG. 11 illustrates a process for image analysis using an embodiment of a partial texture VAE including a mask-aware texture encoding layer (TEL) in the encoder and using partial convolution in the encoder of the partial texture VAE, in accordance with embodiments of the present disclosure;

FIG. 12 illustrates a process for image analysis using another embodiment of a partial texture VAE including a mask-aware global average pooling (GAP) layer in the encoder and using partial convolution in the convolution layers of the encoder of the partial texture VAE, in accordance with embodiments of the present disclosure;

FIG. 13 is a block diagram illustrating a training process for the partial texture VAE of FIG. 12, in accordance with embodiments of the present disclosure;

FIG. 14 is a block diagram illustrating a feature extraction process to extract features from analyzing images using the encoder of the trained partial texture VAE of FIG. 13, in accordance with embodiments of the present disclosure; and

FIG. 15 shows a visualization of the rock cuttings, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”,“continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, whenever a drilling process is involved in an activity, rock cuttings are produced and are generally available at the well site. Cuttings properties may include geological properties observed or measured associated with cuttings. Currently, cuttings are generally under-utilized for the subsurface characterization by geoscientists and reservoir engineers in the oil and gas industry. When these rock cuttings are observed and interpreted by human eyes, it is extremely interpreter-dependent and relatively time consuming as well as physically labor intensive. Accordingly, a need exists for automating the process of cuttings analysis in the industry. To that end, the embodiments described herein provide a domain-based image analysis workflow that includes multiple computational modules to automatically extract relevant geological information from rock cuttings. As used herein, the terms “image”, “digital image”, “photograph”, and “photo” are intended to be used interchangeably. A digital image may be divided into small geometrical subunits called image pixels having pixel values corresponding to the image content. Depending on the content of the image, the digital image may include different color channels, such as red channel image data indicative of target luminance of a red color, blue channel image data indicative of target luminance of a blue color, green channel image data indicative of target luminance of a green color, or grayscale image data indicative of target luminance of a gray color. The image data corresponding with the image content are indicative of target visual characteristics (e.g., luminance and/or color) at one or more specific points (e.g., image pixels) in the image content, for example, by indicating color channel brightness levels (e.g., gray levels). Gray levels are discrete levels (e.g., 0, 1 . . . 255) corresponding to quantized light brightness (e.g., light brightness of color channels, light brightness of gray color) at the image pixels. For example, the brightness level may be at maximum when the gray level has a value of 255 and minimum when the gray level has a value of 0. For example, a digital image may have three color channels (e.g., red (R), green (G), blue (B)), and an image pixel of the digital image may have a pixel value of (R,G,B) (e.g., (255,255,255)). In some embodiments, a digital image may have more than 3 channels per pixel (e.g., hyperspectral images, multispectral images). In some embodiments, a digital image may be a grayscale image and only have one color channel, and an image pixel of the digital image may have a pixel value of corresponding gray level (e.g., 0, 1 . . . 255). The relationship between the gray level of the image pixels and the corresponding brightness at the image pixels is associated with the imaging system used to take the image. In addition, although described herein as systems and methods for analyzing images of drill bit cuttings, it will be appreciated that the embodiments described herein may be capable of analyzing images of other types of rock particles, such as other types of cuttings, cavings, and so forth as well as non-rock objects in the mud, such as mud additives, metal shavings, and foreign objects.

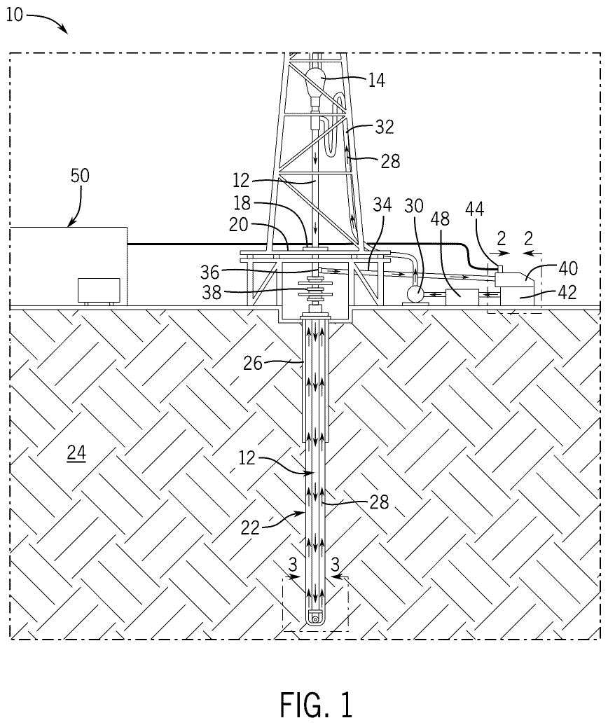

FIG. 1 illustrates a drilling system 10 in accordance with the embodiments described herein. As illustrated, in certain embodiments, a drill string 12 may be suspended at an upper end by a kelly and a traveling block 14 and terminated at a lower end by a drill bit 16 (shown in FIG. 3). The drill string 12 and the drill bit 16 are rotated by a rotary table 18 on a driller floor 20, thereby drilling a borehole 22 into earth formation 24, where a portion of the borehole 22 may be cased by a casing 26. As illustrated, in certain embodiments, drilling fluid or drilling “mud” 28 may be pumped by a mud pump 30 into the upper end of the hollow drill string 12 through a connecting mud line 32. From there, the drilling fluid 28 may be pumped downward through the drill string 12, exiting the drill string 12 through opening in the drill bit 16, and returning to the surface by way of an annulus formed between the wall of the borehole 22 and an outer diameter of the drill string 12. Once at the surface, the drilling fluid 28 may return through a return flow line 34, for example, via a bell nipple 36. As illustrated, in certain embodiments, a blowout preventer 38 may be used to prevent blowouts from occurring in the drilling system 10.

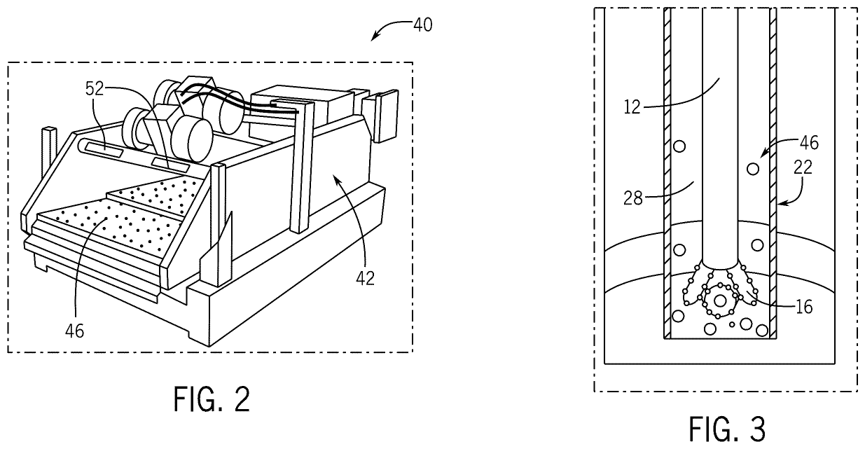

As illustrated in FIG. 1, drill bit cuttings that are formed by the drill bit 16 crushing rocks in the formation 24 may typically be removed from the returned drilling fluid 28 by a shale shaker 40 in the return flow line 34 such that the drilling fluid 28 may be reused for injection, where the shale shaker 40 includes a shaker pit 42 and a gas trap 44. The drilling fluid 28 may then be delivered to a mud pit 48 from which the mud pump 30 may draw the drilling fluid 28. FIG. 2 illustrates drill bit cuttings 46 that have been removed from the drilling fluid 28 in the shaker pit 42 of the shale shaker 40. In FIG. 2, one or more cameras 52 may be used to capture the drill bit cuttings 46. In addition, FIG. 3 illustrates how drill bit cuttings 46 may be created by the drill bit 16, and then flow back up within the drilling fluid 28 through an annulus formed between the wall of the borehole 22 and an outer diameter of the drill string 12.

In addition, as illustrated in FIG. 1, in certain embodiments, an analysis and control system 50 (e.g., a mud logging unit) may be used to control the drilling system 10, as well as provide analysis of the drill bit cuttings 46, as described in greater detail herein. In particular, in certain embodiments, the analysis and control system 50 may be configured to automatically analyze images of the drill bit cuttings 46 that are automatically captured by cameras (e.g., the one or more cameras 52 shown in FIG. 2) during performance of the drilling system 10 illustrated in FIG. 1, as described in greater detail herein. As illustrated in FIG. 2, in certain embodiments, the one or more cameras 52 may be directly associated with (e.g., directly attached to or disposed adjacent to or in close proximity to) the shale shaker 40. However, in other embodiments, the one or more cameras 52 may be other types of cameras not directly associated with the shale shaker 40.

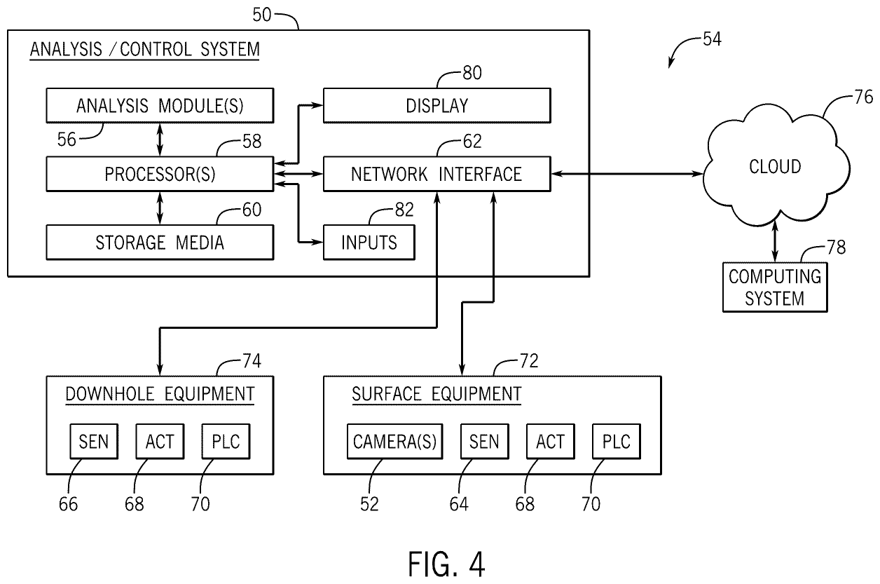

FIG. 4 illustrates a system 54 that includes an analysis and control system 50 to monitor and control the drilling system 10 of FIG. 1, as described in greater detail herein. In certain embodiments, the analysis and control system 50 may include one or more analysis modules 56 (e.g., tools or instruments) that may be configured to perform various functions of the embodiments described herein including, but not limited to, utilizing certain analysis algorithms to analyze images of drill bit cuttings 46 that are captured by the one or more cameras 52, as described in greater detail herein. In certain embodiments, to perform these various functions, an analysis module 56 executes instructions on one or more processors 58 of the analysis and control system 50, which may be connected to one or more storage media 60 of the analysis and control system 50. Indeed, in certain embodiments, the one or more analysis modules 56 may be stored in the one or more storage media 60. In certain embodiments, the one or more analysis modules 56 include analysis hardware (e.g., analysis circuitry) and/or software including processor executable instructions and associated data.

In certain embodiments, the one or more processors 58 may include a microprocessor, a microcontroller, a processor module or subsystem, a programmable integrated circuit, a programmable gate array, a digital signal processor (DSP), or another control or computing device. In certain embodiments, the one or more storage media 60 may be implemented as one or more non-transitory computer-readable or machine-readable storage media. In certain embodiments, the one or more storage media 60 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the processor-executable instructions and associated data of the analysis module(s) 56 may be provided on one computer-readable or machine-readable storage medium of the storage media 60 or, alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 60 may be located either in the machine running the machine-readable instructions, or may be located at a remote site from which machine-readable instructions may be downloaded over a network for execution.

In certain embodiments, the processor(s) 58 may be connected to a network interface 62 of the analysis and control system 50 to allow the analysis and control system 50 to communicate with various surface sensors 64 (Internet of Things (IoT) sensors, gauges, and so forth) and/or downhole sensors 66 described herein, as well as communicate with actuators 68 and/or PLCs 70 of surface equipment 72 and/or of downhole equipment 74 for the purpose of monitoring and/or controlling operation of the drilling system 10, as described in greater detail herein. In addition, in certain embodiments, the network interface 62 may also facilitate the analysis and control system 50 to communicate with one or more cameras 52, as described in greater detail herein. In certain embodiments, the network interface 62 may also facilitate the analysis and control system 50 to communicate data to a cloud-based service 76 (or other wired and/or wireless communication network) to, for example, archive the data or to enable external computing systems 78 (e.g., cloud-based computing systems, in certain embodiments) to access the data and/or to remotely interact with the analysis and control system 50. For example, in certain embodiments, some or all of the analysis modules 56 described in greater detail herein may be executed via cloud and edge deployments.

In certain embodiments, the analysis and control system 50 may include an electronic display 80 configured to display a graphical user interface to present results on the analysis described herein. In addition, in certain embodiments, the graphical user interface may present other information to operators of the equipment 72, 74. For example, the graphical user interface may include a dashboard configured to present visual information to the operators. In certain embodiments, the dashboard may show live (e.g., real-time) data as well as the results of the analysis described herein. In addition, in certain embodiments, the analysis and control system 50 may include one or more input devices 82 configured to enable the operators to, for example, provide commands to the equipment 72, 74 described herein. In addition, in certain embodiments, the display 80 may include a touch screen interface configured to receive inputs from operators.

It should be appreciated that the system 54 illustrated in FIG. 4 is only exemplary, and that the system 54 may have more or fewer components than shown, may combine additional components not depicted in the embodiment of FIG. 4, and/or the system 54 may have a different configuration or arrangement of the components depicted in FIG. 4. In addition, the various components illustrated in FIG. 4 may be implemented in hardware, software, or a combination of both hardware and software, including one or more signal processing and/or application specific integrated circuits. Furthermore, the operations of the system 54 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

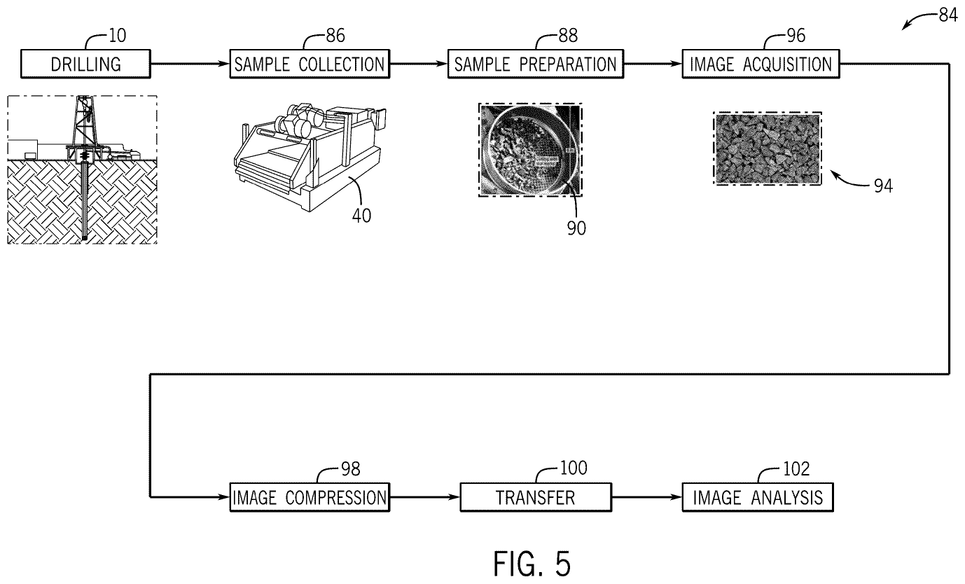

In conventional systems, drill bit cuttings 46 are analyzed by mud loggers in a mud logging unit. These conventional systems are generally human-dependent. The embodiments described herein enhance the analysis of such drill bit cuttings 46. FIG. 5 illustrates a cuttings collection and image acquisition workflow 84 that may be performed by the analysis and control system 50 of FIG. 4. As illustrated in FIG. 5, the cuttings collection and image acquisition workflow 84 begins with a drilling system 10 that generates rock particles (e.g., that include the drill bit cuttings 46 described above). Then, the rock particles are collected, for example, from a shale shaker 40, as described with respect to FIG. 2 (e.g., sample collection 86).

Then, in certain embodiments, the rock particles may be prepared for analysis by, for example, drying the rock particles in an oven for analysis (e.g., sample preparation 88). In addition, in certain embodiments, the sample preparation 88 may include sieving the rock particles using one or more meshes 90 to select cuttings 46 that fall in certain ranges of sizes. In certain embodiments, the sizes of the meshes 90 may be in a range of between 0.25 millimeters (mm) and 3.0 mm and may be approximately 0.25 mm, approximately 0.50 mm, approximately 0.75 mm, approximately 1.0 mm, approximately 1.25 mm, approximately 1.50 mm, approximately 1.75 mm, approximately 2.0 mm, approximately 2.25 mm, approximately 2.50 mm, approximately 2.75 mm, or approximately 3.0 mm. It will be appreciated that consecutive meshes 90 through which the rock particles may be sieved may begin with larger meshes 90 followed by progressively smaller meshes 90 such that larger cuttings 46 are sieved sooner and smaller cuttings 46 are sieved later until such point where the sieved rock particles are so fine that they are no longer considered cuttings 46 per se. It will also be appreciated that the size of a particle cutting 46 is the smallest axis of the cutting 46 when the cutting 46 is approximated as an ellipsoid. In certain embodiments, the sample preparation 88 may include placing the sieved cuttings 46 in a sample tray having a relatively vivid background color (e.g., pure magenta (e.g., with RGB values of 255, 0, 255), pure blue (e.g., with RGB values of 0, 0, 255), pure green (e.g., with RGB values of 0, 255, 0), and so forth). In general, such colors do not exist in nature and, accordingly, help instance segmentation models avoid detecting the background of the sample tray as part of the instance. In certain situations, the sample tray may be prepared by a human or an automated system, so the distribution of the cuttings 46 is often random. For example, the cuttings 46 may be touching or piled in some areas on the sample tray and may be sparsely distributed in other areas.

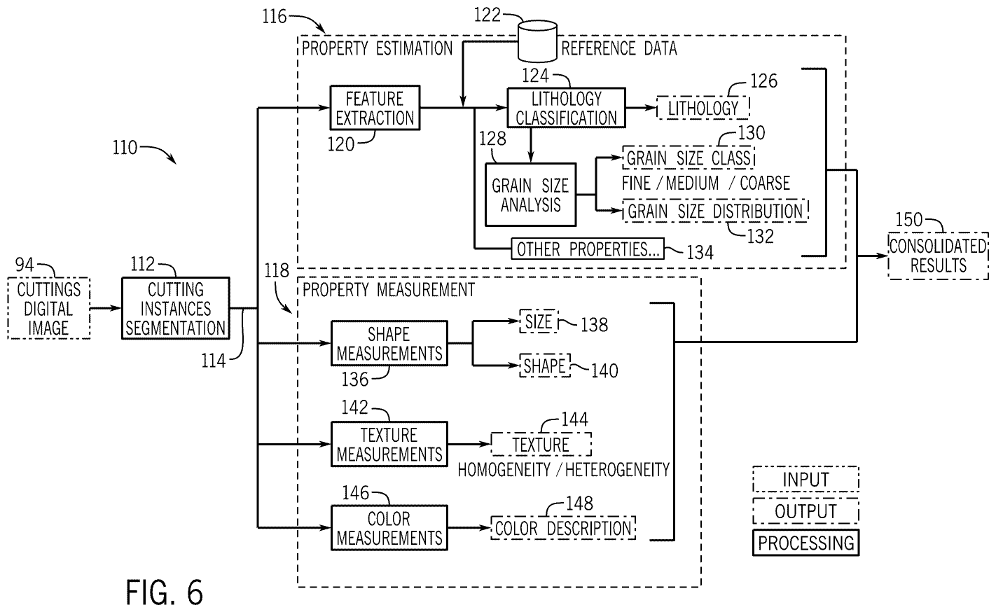

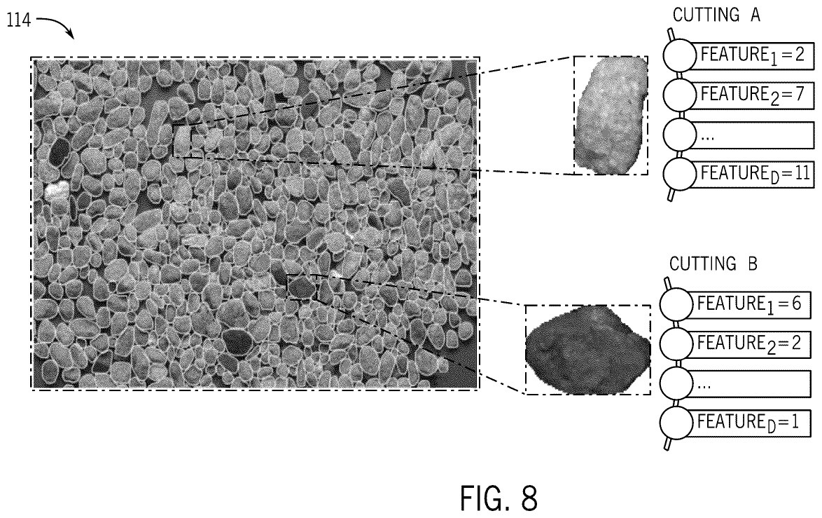

In certain embodiments, an image 94 of the cuttings 46 may be taken (e.g., image acquisition 96) by imaging devices (e.g., the one or more cameras 52). The examples below are given with cameras detecting visible light spectrum, but the same methods may be applied to an image taken with infrared (IR) or ultraviolet (UV) cameras detecting light in UV or IR domains. As described in greater detail herein, in certain embodiments, during the image acquisition 96, illumination, color, and resolution of the image 94 may be calibrated and standardized in order to obtain quantitative and reliable measurements of pixel values between images 94. For example, in certain embodiments, color/illumination calibration may be obtained by using colorimetry algorithms against previously analyzed images 94 and a current image of interest 94, while resolution calibration may be based on lens focal length, focal distance, and sensor size/resolution for the current image 94 of interest as compared to that of previously analyzed images 94. All of these parameters may vary, but the final image is “calibrated” and the same objects may be digitalized with reasonably near values. Pixel values (e.g., the images 94 may be digital images) and size are, therefore, treated as effective measurements of the particle rather than mere representation. The embodiments described herein enable the creation of such calibrated and error-assessed input images 94. Without such calibration, final object classification may vary because of the acquisition rather than because of any real-world difference. In certain embodiments, an optical image of the sample under the visible light may be taken. In certain embodiments, an optical image of the same sample under the UV light, which may cause the fluorescence of some minerals and oil (if oil is trapped in the cuttings), may be taken. This may be a clue for certain rock types or existence of oil in the geological formation which the cutting belonged to. In certain embodiments, the optical images of the same sample taken under different light spectrum (e.g., visible light, UV, IR) may be combined for image analysis of the sample, as described in FIG. 6 and FIG. 8.

Then, in certain embodiments, the image 94 (e.g., digital image) of the cuttings 46 may be compressed for easier transfer (e.g., image compression 98). In particular, well sites are quite often in relatively remote locations where the available network bandwidth may be relatively slow. Accordingly, compressing the images 94 of cuttings 46 may facilitate transfer of the images 94. It will be appreciated that compressing the images 94 of cuttings 46 may not be as beneficial if there is higher bandwidth at the well site (e.g., when the well site has cable internet access). Then, in certain embodiments, the image 94 of the cuttings 46 may be transferred (e.g., image transfer 100), for example, to the analysis and control system 50 and/or the computing system 78 illustrated in FIG. 4 for analysis, as described in greater detail herein. The analysis and control system 50 may be at the well site or in a remote location. Then, in certain embodiments, analysis of the image 94 of the cuttings 46 (e.g., image analysis 102) may include extraction of geologically meaningful information relating to the cuttings 46 from the image 94, as described in greater detail herein.

The embodiments described herein determine measurements from images 94 of cuttings 46 that relate to lithology of the formation 24 from which the cuttings 46 are generated based on lithology geological scientific definitions. In general, the lithology of a rock unit is a description of its physical characteristics visible at an outcropping, in hand or core samples, or with low magnification microscopy. Such physical characteristics include, but are not limited to, color, texture, grain size, and composition. Lithology may refer to either a detailed description of these physical characteristics, or a summary of the gross physical character of a rock. Examples of lithology types may include sandstone, slate, basalt, limestone, and so forth. As such, color, texture, and grain size are physical characteristics of a type of lithology, and the workflows described herein illustrate how these physical characteristics may be measured, extracted, and consolidated to obtain automated lithological image recognition.

The embodiments described herein apply to analysis of calibrated images 94 of prepared cuttings 46, regardless of the particular methods used to achieve the sample preparation 88, the image acquisition 96, the image compression 98, and the image transfer 100, described with respect to FIG. 5.

In certain embodiments, the analysis and control system 50 may be configured to separate pixels of individual rock particles from multiple particles (e.g., cuttings 46) depicted in an image 94 (e.g., calibrated image). In addition, in certain embodiments, the analysis and control system 50 is configured to determine relevant morphological (e.g., size, shape, and so forth), color, and texture data from one or more individual rock particles (e.g., cuttings 46) depicted in a calibrated image 94. In addition, in certain embodiments, the analysis and control system 50 may be configured to utilize extracted information from calibrated images 94 to perform geological/lithological classification at a plurality of different hierarchical levels (e.g., at a single particle/cutting level, at a single sample level of a plurality of cuttings, at a particular depth interval within a borehole 22, for a particular geological formation 24, for an entire well, for an entire well field, and so forth). As described in greater detail herein, consolidating the analysis results in a plurality of hierarchical levels enables operators to analyze the cuttings 46 in a much more robust (and automated and more accurate) manner than conventional techniques. In addition, in certain embodiments, the analysis and control system 50 may be configured to utilize the information derived herein based on the calibrated images 94 to create a mud logging report. In addition, in certain embodiments, the analysis and control system 50 may be configured to output from the calibrated images 94 any relevant information that can be integrated with other well-related answer products. In addition, in certain embodiments, the analysis and control system 50 may be configured to utilize a supervised machine learning model (e.g., from another well in the same field or another field with similar geological setting) to infer the lithology type from a calibrated image 94 from the current well. In addition, in certain embodiments, the analysis and control system 50 may be configured to utilize all of this type of information to automatically adjust operating parameters of a drilling system 10 (e.g., drilling fluid composition, drill bit speed, and so forth), as described in greater detail herein.

While the cuttings collection and image acquisition workflow 84 illustrated in FIG. 5 has been described with particular reference to analyzing cuttings 46 to determine geologically meaningful information relating to the cuttings 46 from images 94, the embodiments described herein may be extended to the analysis of images 94 to identify features of other types of objects, rather than just cuttings 46.

In certain embodiments, object-based image analysis (OBIA) may be used to analyze the images 94 (e.g., calibrated images). OBIA generally involves grouping a number of pixels in a digital image into shapes with a meaningful representation of objects based on either spectral or spatial similarity or an external variable (e.g., soil or geological unit). OBIA may be used to address complex classes that are defined by spatial and hierarchical relationships within and during the classification process. In some embodiments, color and texture analysis may be used to analyze the images 94. In geology, rocks are characterized by texture and color. Thus, a key step is to extract color and texture features from the images 94 for a variety of downstream image analysis tasks, such as clustering, image retrieval, classification, and manifold representation for visualizing the rock particles distribution to enable the OBIA. Analysis of the images 94 may include image segmentation, feature extraction, and classification, as illustrated in FIG. 6. As mentioned previously, calibrated images 94 may be used in the image analysis to obtain more reliable results. The embodiments described herein focus on feature extraction and classification analysis of calibrated images 94. Certain embodiments implement lithological recognition and/or classification from images 94 of cuttings 46 by applying neural network (NN) and machine learning (ML) techniques. It should be noted that, the feature extraction technique described herein may be applied to other images (e.g., rock core images, borehole images) and/or images in any domain, such as remote sensing and medical imaging.

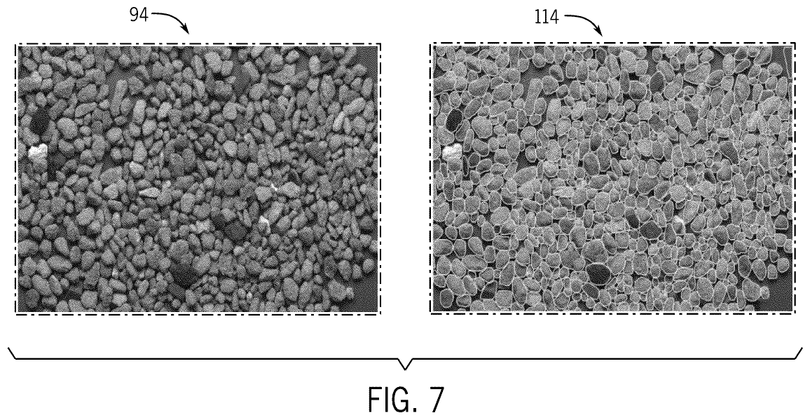

FIG. 6 illustrates an example workflow 110 of the image analysis for an image 94 (e.g. calibrated image) by the system 54. The image 94 (e.g., digital image) may be input into a cutting instances segmentation module 112 (e.g., tools or instruments) of the system 54 to obtain segmented individual cutting instance images 114 (shown in FIG. 7). The cutting instances segmentation module 112 may identify and separate individual objects within the calibrated image 94, for example, by detecting the boundaries of each object and assigning a unique label to each object, as illustrated in FIG. 7 and FIG. 8. FIG. 7 shows an example of a calibrated image 94 and the corresponding segmented individual cutting instance images 114. In certain embodiments, the cutting instances segmentation module 112 may include analysis hardware (e.g., analysis circuitry) and/or software including processor executable instructions and associated data. In certain embodiments, the cutting instances segmentation module 112 may utilize Mask R-CNN (Region-based Convolutional Neural Networks) to identify various objects in the calibrated image 94, which has been found to outperform conventional segmentation methods. A Mask R-CNN model is trained in a supervised manner, and it has been found that the same approach may be taken to efficiently build a system to run the instance segmentation using any type of image (e.g., digital image, distance image, etc.) and rock particle scene (e.g., cuttings, mining site, space, etc.) by training the model with relevant datasets.

The segmented individual cutting instance images 114 may be used in a rock property estimation process 116 and a rock property measurement process 118. For instance, in the rock property estimation process 116, the segmented individual cutting instance images 114 may be input into a feature extraction module 120 (e.g., tools or instruments) of the analysis and control system 50. In certain embodiments, the feature extraction module 120 may include analysis hardware (e.g., analysis circuitry) and/or software including processor executable instructions and associated data The feature extraction module 120 may analyze the segmented individual cutting instance images 114 using reference data 122 (e.g., baseline cuttings used for reference) and output a set of parameters (features) representing the color and textural properties of the cutting instance, which may be key visual properties to identify rock types, as illustrated in FIG. 8. Thus, cutting features are a set of values that represent or summarize color and texture information of a cutting instance image. FIG. 8 shows an example of the segmented individual cutting instance images 114 with individual cutting instance images (e.g., cutting A and cutting B) indicated with corresponding set of parameters for number D of features (e.g., feature₁,feature₂ . . . feature_{D}). As illustrated in FIG. 8, the individual cutting instance images (e.g., cutting A, cutting B) in the segmented individual cutting instance images 114 may have arbitrary sizes, shapes (e.g., height (H), width (W)), and colors. The feature extraction module 120 may analyze the segmented individual cutting instance images 114, and each cutting instance image (Ii) may be transformed from the image space, Iᵢ ∈ R^{(Hi×Wi×3)} (e.g., height (Hi), width (Wi), 3 color channels (e.g., red, green, blue)), to a D-dimensional feature vector space, \vec{V}ᵢ ∈ R^{D}. In some embodiments, the cutting instance image (Ii) may be a grayscale image and have only one color channel. The D-dimensional feature vector space R^{D} may include number D of feature (e.g., feature₁, feature₂ . . . feature_{D}) axes, and the feature vector \vec{V}ᵢ may have a set of parameters along respective feature axes in the feature vector space R^{D}. In certain embodiments, different types of images representing different physical properties of the same rock particle samples may be obtained without changing the position of the samples in the sample tray. In such cases, we may combine those images and generate a single multi-channel image. Thus, the transformation is from the image space Iᵢ ∈ R^{(Hi×Wi×C)}, where C is the number of channels (e.g., physical properties of the rock particle samples, such as colors), to a D-dimensional feature vector space \vec{V}ᵢ ∈ R^{D}. For example, in certain embodiments, fluorescence of the minerals in the cuttings may be a clue for certain rock types, and an optical image of the same sample (e.g., cuttings 46) under the UV light, which may cause the fluorescence of the minerals, may be combined with the calibrated image 94 (e.g., obtained using visible light) to create a 6 channel image (e.g., 3 color channels for the image taken with UV light and 3 color channels for the image taken with visible light). In some embodiments, the calibrated image 94 may include hyperspectral images (e.g., continuous ranges of wavelengths) and/or multispectral images (e.g., discrete targeted wavelengths) of the cuttings taken by using imaging spectroscopy. These hyperspectral images and/or multispectral images may have more than 3 color channels and may include spectral signatures for minerals in the cuttings, which may be used to identify the minerals. In this case, the transformation will be from an image space Iᵢ ∈ R^{(Hi×Wi×6)} to the D-dimensional feature vector space, \vec{V}ᵢ ∈ R^{D}. The feature vectors of the segmented individual cutting instance images 114 may be used by a lithology classification module 124 (e.g., tools or instruments) of the analysis and control system 50 to determine the lithology 126 of the cuttings 46, as described in greater detail herein. In certain embodiments, the lithology classification module 124 may include analysis hardware (e.g., analysis circuitry) and/or software including processor executable instructions and associated data. For a lithology type of rock (e.g., sandstone), a grain size analysis module 128 (e.g., tools or instruments) of the analysis and control system 50 may be used to analyze each individual cutting 46 to identify a grain size class (e.g., fine, medium, coarse, and so forth) 130 and a grain size distribution 132, among other grain size-related properties, of each individual cutting 46. In certain embodiments, the grain size analysis module 128 may include analysis hardware (e.g., analysis circuitry) and/or software including processor executable instructions and associated data.

The feature vectors of the segmented individual cutting instance images 114 may be used with other properties 134 (e.g., properties not easily extracted from digital images) to estimate rock properties, as described in greater detail herein. For example, other properties 134 may include guided manual property descriptions, associated well log values, or other external data such as, but not limited to, stratigraphic geological sequences, while-drilling logs, 3D model properties, cutting physical analysis (e.g., diffractometry, calcimetry, acid test), or any other information that may be useful to resolve lithology classification ambiguities. In certain embodiments, the other properties 134 may be determined by using instruments/tools (e.g., surface equipment 72, downhole equipment 74), analysis hardware (e.g., analysis circuitry), and/or software including processor executable instructions and associated data.

As illustrated in FIG. 8, the individual cutting instance images (e.g., cutting A, cutting B) in the segmented individual cutting instance images 114 may have arbitrary sizes, shapes, and colors. The property measurement process 118 may use a shape measurements module 136 (e.g., tools or instruments) of the analysis and control system 50, and the segmented individual cutting instance images 114 may be analyzed by the shape measurement module 136 based on individual instances to determine the size 138 and shape 140 of the individual instances. The property measurement process 118 may use a texture measurements module 142 (e.g., tools or instruments) of the analysis and control system 50, and the segmented individual cutting instance images 114 may be analyzed by the texture measurement module 142 based on individual instances to determine the texture 144 of the individual instances, such as homogeneous, heterogeneous, laminated, grainy, and so forth. The property measurement process 118 may also use a color measurements module 146 (e.g., tools or instruments) of the analysis and control system 50, and the segmented individual cutting instance images 114 may be analyzed by the color measurement module 146 based on individual instances to determine the color 148 of the individual instances. In certain embodiments, the shape measurements module 136, the texture measurement module 142, and the color measurements module 146 may include analysis hardware (e.g., analysis circuitry) and/or software including processor executable instructions and associated data. The outputs of the property estimation process 116 (e.g., the lithology 126, the grain size class 130, the gran size distribution 132) and the outputs of the property measurement process 118 may be combined to obtain consolidated results 150.

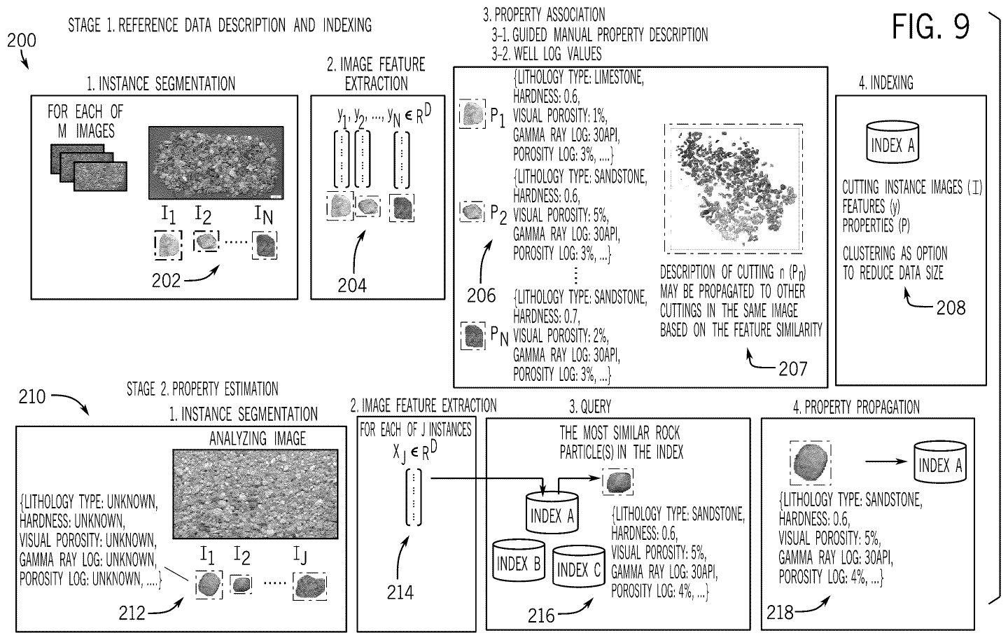

The property estimation process 116 may include two stages: stage one for reference data description and indexing (e.g., for baseline cuttings used for reference); and stage two for property estimation of a cutting instance image based on the reference data description and indexing obtained in stage one. FIG. 9 shows a workflow 200 of stage one for using the reference data 122 for data description and indexing. In some embodiments, the workflow 200 may include instruments/tools (e.g., surface equipment 72, downhole equipment 74), hardware (e.g., analysis circuitry), and/or software including processor executable instructions and associated data. The reference data 122 may include image data for a set of M images (e.g., calibrated images 94) obtained when analyzing previous wells or previous data of the current well.

The workflow 200 may include instance segmentation (process 1), image feature extraction (process 2), property association (process 3), and indexing (process 4). In process 1 of the workflow 200, each image of the set of M images may be analyzed (e.g., by the cutting instances segmentation module 112) to obtain respective segmented individual cutting instance images having a number (e.g., N) of individual cutting instance images 202 (e.g., I₁, I₂, . . . I_{N}). The cuttings in the individual cutting instance images 202 (e.g., I₁, I₂, . . . I_{N)} may be used as reference cuttings or baseline cuttings. In process 2 of the workflow 200, the segmented individual cutting instance images may be analyzed (e.g., by the feature extraction module 120) to obtain corresponding set of parameters for number D of features (e.g., feature₁,feature₂ . . . feature_{D)} for the individual cutting instance images 202 (e.g., I₁, I₂, . . . I_{N}). Thus, the individual cutting instance images 202 (e.g., I₁, I₂, . . . I_{N}) may be transformed from the image space to corresponding feature vectors 204 (e.g., represented by corresponding matrix y₁, y₂, . . . y_{N}) in the D-dimensional feature vector space R^{D}.

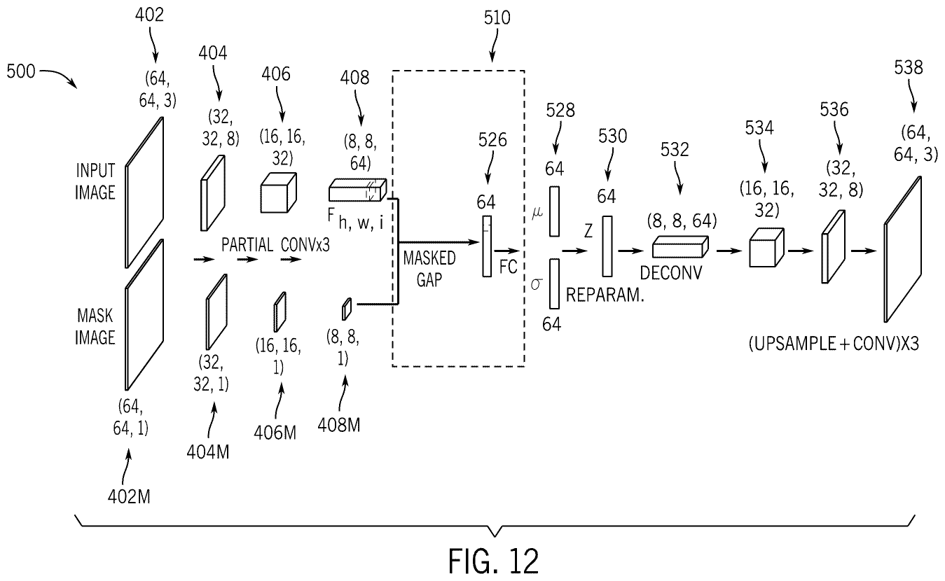

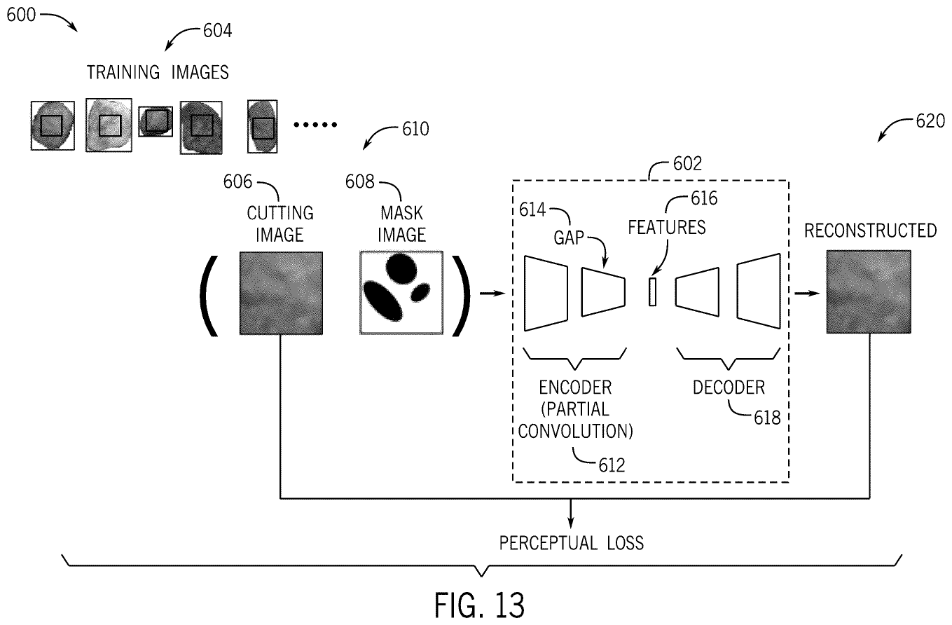

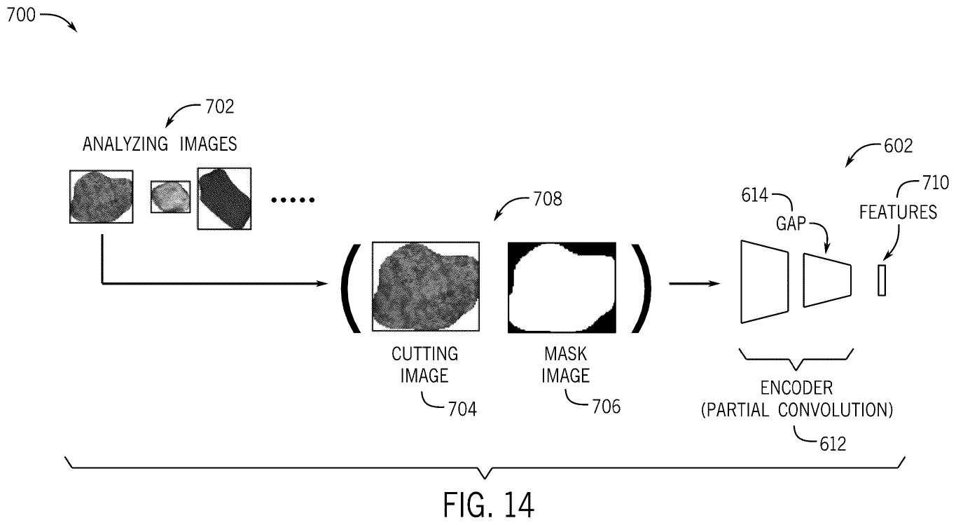

In process 3 of the workflow 200, the individual cutting instance images 202 (e.g., I₁,I₂, . . . I_{N}) may be manually described by geologists (e.g., 3-1 guided manual property description) who is guided by a cutting description software, which is described in detail in FIGS. 12 and 13. The cutting description software may include a description wizard having multiple entries, such as lithology type, hardness, visual porosity, etc. Some of the entries of the description wizard may not be easily extracted from digital images. In process 3 of the workflow 200, well log values may also be used for property description (e.g., 3-2 Well log values association). Well log may include a detailed record for the geologic formation (e.g., the formation 24). The detailed record may include information regarding the geologic properties (e.g., lithology, layer, depositional environments) and petrophysical characterization (e.g., water saturation, porosity, permeability, volume of shale) of the geologic formation, which may be used to control the drilling device or a drilling plan of the drilling system 10. Well log may be a function of the borehole depth. For example, cuttings 46 may be collected at a depth of the borehole 22, and the well log value at the depth may be associated with the cuttings from the same depth of the same well or different wells, as illustrated in FIG. 14. This approach may be used, for example, when the reference data of stage one includes a well with cuttings and well log measurements, and the cutting instance image in stage two includes another well with cuttings but without well log measurements. A property 206 (e.g., P₁, P₂, . . . P_{N}) of the corresponding individual cutting instance images 202 (e.g., I₁, I₂, . . . I_{N}) may be determined by using the guided manual property description, associated well log values, or other external data such as, but not limited to, stratigraphic geological sequences, while-drilling logs, 3D model properties, cutting physical analysis (e.g., diffractometry, calcimetry, acid test), or any other information that may be useful to resolve lithology classification ambiguities. The property 206 may include properties of the reference cuttings in the individual cutting instance images 202, such as lithology type, hardness, visual porosity, gamma ray log, porosity log, etc. For example, P₁ may include a description “Lithology type: Limestone; Hardness:0.6, Visual porosity: 1%, Gamma Ray log: 30API; Porosity log: 3% . . . .” P₂ may include a description “Lithology type: Sandstone; Hardness:0.6,Visual porosity: 5%, Gamma Ray log: 30API; Porosity log: 3% . . . .” P_{N} may include a description “Lithology type: Sandstone; Hardness:0.7, Visual porosity: 2%, Gamma Ray log: 30API; Porosity log: 3% . . . .” The property description of the Nth reference cutting (P_{N}) may be propagated to other cuttings in the same segmented individual cutting instance images based on the feature similarity, and a view 207 (e.g., two-dimensional (2D) view, three-dimensional (3D) view) of the property description of the cuttings may be displayed on a user interface.

In process 4 of the workflow 200, the cutting instance images (e.g., I₁, I₂, . . . I_{N}), the feature vectors 204 (e.g., represented by corresponding matrix y₁, y₂, . . . y_{N}), and the corresponding property 206 may be indexed and stored together in an index dataset 208 (e.g., index A). The index dataset 208 may contain the cutting instance images (e.g., I₁, I₂, . . . I_{N}), the feature vectors 204 (e.g., represented by corresponding matrix y₁, y₂, . . . y_{N}), and the corresponding property 206 (e.g., P₁, P₂, . . . P_{N}) for the set of M images in the reference data 122. In process 4, a clustering technique may be applied to the index dataset 208 to reduce the data size of the index. The clustering technique may be a data compression technique or redundancy reduction technique. For example, when there are multiple cutting instances that are visually very similar and corresponding feature distances (e.g., the squared Euclidean (L2-squared) distance) in the feature vector space R^{D} are very close to each other, the cutting instances may be grouped into a cluster and only the representative cutting instance may be retained, wherein the representative cutting instance may be the centroid cutting instance of the cluster. Multiple index databases may be created by using different sets of M images. For example, various index datasets (e.g., index A, index B, index C) may be created from images of specific geographical locations or specific geological formations.

FIG. 9 also shows a workflow 210 for property estimation (e.g., lithology type, hardness, visual porosity, Gamma ray log, porosity log) of a cutting instance image using the property 206 and the index dataset 208 obtained in the workflow 200. In some embodiments, the workflow 210 may include instruments/tools (e.g., surface equipment 72, downhole equipment 74), hardware (e.g., analysis circuitry), and/or software including processor executable instructions and associated data. The workflow 210 may include instance segmentation (process 1), image feature extraction (process 2), query (process 3), and property propagation (process 4). In process 1 of the workflow 210, an image (e.g., a calibrated image 94) may be analyzed (e.g., by the cutting instances segmentation module 112) to obtain segmented individual cutting instance images having a number (e.g., J) of unknown individual cutting instance images 212 (e.g., I₁, I₂, . . . I_{J}) (e.g., unknown lithology type, unknown hardness, unknown visual porosity, unknown Gamma ray log, unknown porosity log). In process 2 of the workflow 210, the segmented individual cutting instance images may be analyzed (e.g., by the feature extraction module 120) to obtain a set of parameters for number D of features (e.g., feature₁,feature₂ . . . feature_{D}) for each of the unknown individual cutting instance images 212 (e.g., I₁, I₂, . . . I_{J}). Thus, each of the unknown individual cutting instance images 212 (e.g., I₁, I₂, . . . I_{J}). may be transformed from the image space to corresponding feature vectors 214 (e.g., represented by corresponding matrix xi) in the D-dimensional feature vector space R^{D}. The process 1 and process 2 of the workflow 210 may be repeated for the new images acquired.

The process 3 of the workflow 210 may be used to retrieve a number K of most similar (K≥1) cuttings 216 from the index storage (e.g., index A, index B, index C) for each of the unknown individual cutting instance images 212 (e.g., I₁, I₂, . . . I_{J}) by comparing the feature vector 214 (e.g., represented by corresponding matrix xi) with feature vectors (e.g., represented by corresponding matrix y₁, y₂, . . . y_{N}) of the index storage. As described above, the properties (e.g., lithology type, hardness, visual porosity, Gamma ray log, porosity log) of the number K of most similar cuttings 216 may be obtained in the property association of stage one. Distances (e.g., the squared Euclidean (L2-squared) distance) in the feature vector space R^{D} between the feature vector 214 (e.g., represented by corresponding matrix xi) and the feature vectors (e.g., represented by corresponding matrix y₁, y₂, . . . y_{N}) of the index storage may be calculated, and the nearest neighbor search method may be used to determine the number K of most similar cuttings 216 by finding the number K of smallest distances.

In the process 4 of the workflow 210, a corresponding property description 218 (e.g., lithology type, hardness, visual porosity, Gamma ray log, porosity log) may be determined for each of the unknown individual cutting instance images 212 (e.g., I₁, I₂, . . . I_{J}) by using the K most similar rock particles 216. For instance, index dataset in the index storage might be selected to have a better accuracy of query and thus the property estimation. For example, in FIG. 9, the index dataset A may be selected among other options such as index dataset B and index dataset C based on geographical locations, geological formations, well locations, depths in a well, etc. When K equals to 1, the properties of the retrieved cutting 216 may be simply copied to the unknown individual cutting instance image 212 being analyzed, as illustrated in FIG. 9. For example, when K equals to 1, the most similar rock particle in the index may have the property description as ““Lithology type: Sandstone; Hardness:0.6, Visual porosity: 5%, Gamma Ray log: 30API; Porosity log: 4% . . . ,” and the unknown individual cutting instance image 212 being analyzed may be determined to have the same property description. When K is greater than 1, the properties of the retrieved cuttings 216 may be summarized and copied to the unknown individual cutting instance image 212 being analyzed using various ways. For example, for categorical property (such as Lithology class), the probability may be calculated for each class and the most probable category may be selected.

In some embodiments, texture features may be extracted from the cutting instance images and used to analyze the rock particles. Texture generally refers to the spatial organization of a set of basic elements or primitives (e.g., textons), which are fundamental microstructures in images and basic units of pre-attentive human visual perception. Extracting texture features from the cutting instance images may be different than extracting other features (e.g., color) from the cutting instance images due to properties of texture. For example, while color may stay invariant during rescaling of images, rescaled version of a cutting instance image may correspond to different texture features, which may be used to distinguish different type of rocks (e.g., fine sandstone and medium sandstone). In addition, texture may stay invariant during rotation and translation of an image (e.g., a cutting instance image), accordingly, rotated or translated versions of the image may be assigned with the same or very similar texture features as the original image.

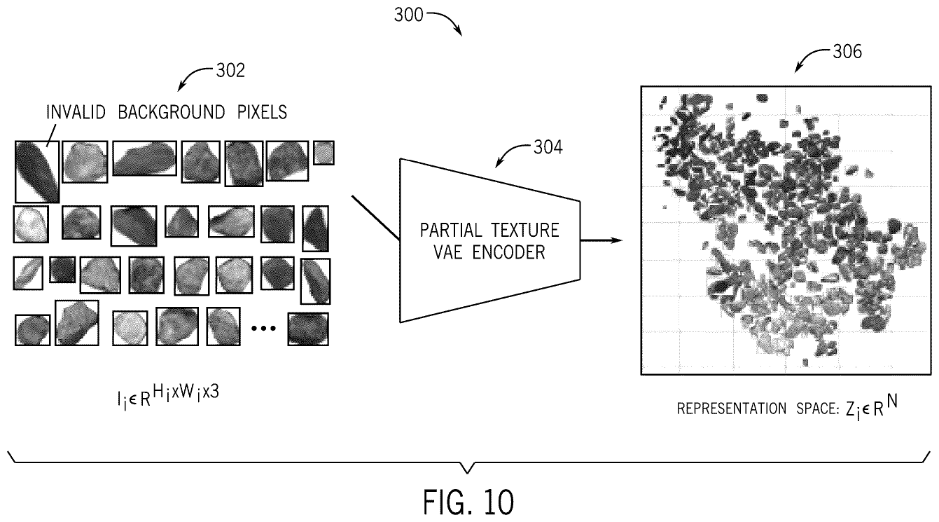

Existing feature extraction techniques may be limited on extracting texture features from cutting instance images due to the properties of texture, such as spatial information captured in the features, feature size depending on input size, shape similarity affected by the existence of background, blurry reconstructed image caused by the pixel-based reconstruction loss, and the like. For example, in some embodiments, the segmented individual cutting instance images 212 may contain background pixels of the background (e.g., the sample tray) used during the image acquisition 96, when taking an image of the cuttings 46. For example, rock particles in the cuttings 46 may have arbitrary size and shape, accordingly, the images of the rock particles in the segmented individual cutting instance images 212 (e.g., Iᵢ ∈ R^{(Hi×Wi×3)}) may have arbitrary sizes and shapes, thereby leaving a portion of the segmented individual cutting instance images 212 (e.g., corners) filled with background pixels, as illustrated in FIG. 10. The background pixels do not represent any feature of the rock particles and are counted as invalid pixels when transforming the segmented individual cutting instance images 212 (Ii) from the image space, Iᵢ ∈ R^{(Hi×Wi×3)} (e.g., height (Hi), width (Wi), 3 color channels (e.g., red, green, blue)), to the D-dimensional feature vector space, \vec{V}ᵢ ∈ R^{D}. In some embodiments, the background pixels may be cropped and only the center of the segmented individual cutting instance images may be used for extracting the features of the rock particles. However, some segmented individual cutting instance images may include global texture representations, and using only the center of the segmented individual cutting instance images may miss the global texture representation. In some embodiments, some segmented individual cutting instance images may be resized before inputting into a feature extraction module to make the input image size uniform, however, resizing may deform the geometry and scale of the texture.

Implementations herein are directed to systems and methods to extract features (e.g., colors, textual features) from arbitrary shaped and sized images containing invalid pixels (e.g., background, image error, other object). It should be noted that, the feature extraction technique described herein may be applied to other images (e.g., rock core images, borehole images) and/or images in any domain, such as remote sensing and medical imaging. In some embodiments, an autoencoder (AE) (e.g., in the feature extraction module 120), which may be data driven and/or unsupervised, may be used to extract texture features from images. In some embodiments, a variational autoencoder (VAE) (e.g., in the feature extraction module 120) may be used to control the distribution of the latent space. In some embodiments, a vanilla AE may be used instead of VAE. A global average pooling (GAP) layer may be used at the last layer of the encoder to make the feature rotation and translation invariant and scale equivariant. In addition, partial convolution may be used in the encoder to logically ignore the invalid (e.g., background, image error, other object) pixels in the images.

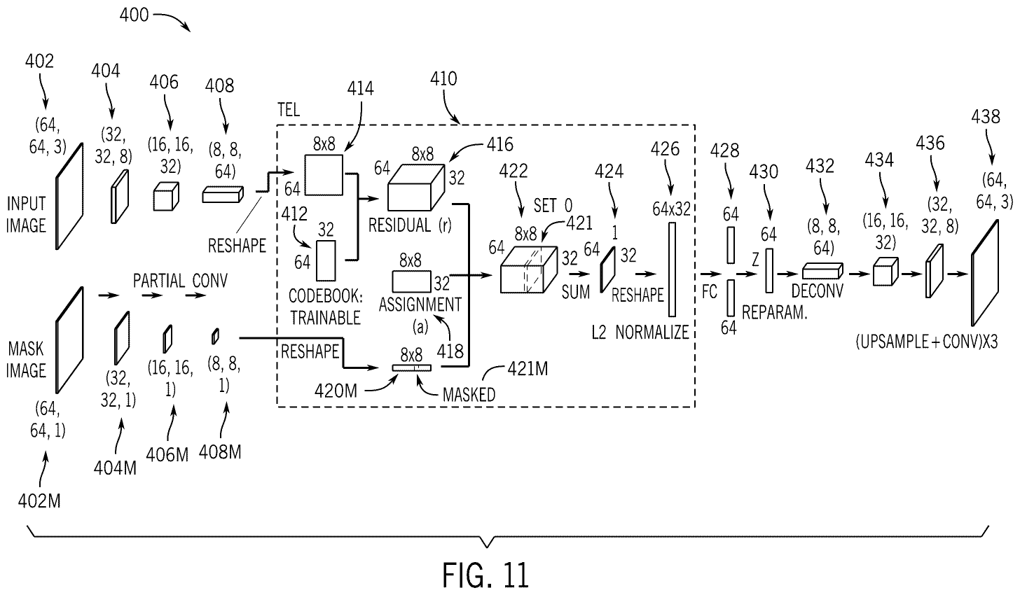

Autoencoder is a general framework including two parts. The first part is an encoder, which encodes the input image Iᵢ ∈ R^{(Hi×Wi×3)} to a latent vector Zᵢ ˜Encoder (Iᵢ)=q(Zi|Iᵢ), as illustrated in FIG. 10. The latent vector Zᵢ is also called as feature or encoding. The second part is an decoder, which decodes the latent vector Zᵢ into an image I\hat{ }˜Decoder(Zᵢ)=p(Iᵢ|Zᵢ). Both encoders and decoders are convolutional neural networks (CNNs), and the network parameters (e.g., weights, biases) may be defined thorough training, as illustrated in FIG. 11. A convolutional neural network (CNN) may include an input layer, one or more hidden layers, and an output layer. The basic unit of computation in a neural network is the neuron/node. Each neuron/node receives input from some other nodes, or from an external source and computes an output. The input layer may include neurons/nodes to receive external inputs, such as input data to the CNN. Each hidden layer is made up of a set of neurons/nodes that have learnable weights and biases, and each neuron/node in the hidden layers may receive some inputs and perform a dot product. The output layer may include neurons/nodes to receive inputs from the hidden layers and output results of the CNN. A CNN uses a feedforward artificial network of neurons to execute image identification or recognition. It uses a reverse feed system for learning and produces a set of weights to calibrate the execution system. A CNN may include multiple layers in the hidden layers, such as convolution layers, pooling layers, and activation layers. The convolution layer extracts low-level features (e.g., lines or edges within an image) from the input data (e.g., operating in a sliding window manner), and the pooling layer reduces variations (e.g., by maxing or value averaging, pooling common features over a particular region of an image). The result may be passed on to further convolution and pooling layers. The activation layers may apply activation functions (e.g., rectified linear unit (ReLU) function, sigmoid function, tanh function) to the results received (e.g., from the pooling layers). Autoencoders may be trained in an unsupervised manner (e.g., no labeled data is used to train the model). Once the model is trained, the encoder part may be used to extract features from images. The encoder and decoder may be created based on residual neural network (ResNet) or similar architecture. The decoder architecture may be symmetrical or non-symmetrical to the encoder architecture.

FIG. 10 illustrate a process 300 for implementing an encoder to transform the segmented individual cutting instance images having invalid background pixels from the image space to the latent vector space. As illustrated in FIG. 10, the images of the rock particles in the segmented individual cutting instance images 302 (e.g., Iᵢ ∈ R^{(Hi×Wi×3)}) may have arbitrary sizes and shapes, thereby leaving a portion of the segmented individual cutting instance images 302 (e.g., corners) filled with background pixels. The background pixels do not represent any feature of the rock particles and are counted as invalid pixels when transforming the segmented individual cutting instance images 302 from the image space Iᵢ ∈ R^{(Hi×Wi×3)} (e.g., height (Hi), width (Wi), 3 color channels (e.g., red, green, blue)), through an encoder 304, to the N-dimensional representation space 306 (e.g., Zᵢ ∈ R^{N}). The encoder 304 may be an encoder of a partial texture VAE, which may logically ignore the background pixels in the segmented individual cutting instance images 302 so that the extracted features in the N-dimensional representation space 306 may not be affected by the background pixels in the segmented individual cutting instance images 302. The encoder 304 may include a texture encoding layer (TEL) and use partial convolution in the convolution layers to be agnostic to geometrical arrangement, image size and shape, and background pixels, as illustrated in FIG. 11.

FIG. 11 shows a process 400 of image analysis using an embodiment of a partial texture VAE, which includes a mask-aware texture encoding layer (TEL) in the encoder and uses partial convolution in hidden layers (e.g., convolution layers, pooling layers) of the encoder of the partial texture VAE. As illustrated in FIG. 11, an input image 402 (e.g., 64×64×3, indicating height (H)=64, width (W)=64, 3 color channels (e.g., red, green, blue)) may be provided to the input layer of the encoder of the VAE together with a corresponding mask image 402M (e.g., 64×64×1). The mask image 402M is a digital image having binary values with masked area having one value and unmasked area having another value (e.g., ∈ {0, 1}^{HX}w with masked area having value “0” and unmasked area having value “1”). The input image 402 and the mask image 402M may be used as input and processed using partial convolution through some hidden layers (e.g. convolution layers, pooling layers) of the encoder of the VAE to generate feature maps for the input image 402. For example, in the illustrated embodiment of FIG. 11, a feature map 404 (e.g., 32×32×8) may be generated by conducting partial convolution using the input image 402 and the mask image 402M, and the mask image 402M may be updated to an updated mask image 404M based on the dimension of the feature map 404 (e.g., 32×32×1). The feature map 404 and the updated mask image 404M may be further processed (e.g., via pooling layers) to generate a feature map 406 (e.g., 16×16×32) and corresponding updated mask image 406M, which may be used to generate a feature map 408 (e.g., 8×8×64) and corresponding updated mask image 408M (e.g., 8×8×1). It should be noted that, although three layers are used to process the input images 402 and the mask image 402M in the illustrated embodiment of FIG. 11, other number (e.g., 2, 4, 5) of layers may be used in other embodiments. During the partial convolution, only the unmasked area in the mask image may contribute to the convolution result, as illustrated in Equation [1] below. Equation [1] describe a partial convolution process on one channel of an input image or a feature map F ∈ R^{(H×W×C)) (e.g., H is height, W is width, and C is number of channels) to generate corresponding next level feature map Z (e.g., H‘×W’×C′, and H′, W′, C′ may be different from H, W, C depending on the filter function) using a filter function (pooling process may also be taken as convolution using a special filter (e.g., average or max)):}

$${Z}_{{h}^{′} , {w}^{′} , {c}^{′}} = \{ \begin{matrix}{W}^{T} ( {X}_{h , w , c}^{F} ⊙ {X}_{h , w}^{M} ) \frac{sum ( 1 )}{sum ( {X}_{h , w}^{M} )} + b , & if sum ( {X}_{h , w}^{M} ) > 0 \\ 0 , & otherwise\end{matrix} \qquad [ 1 ]$$

where W is a matrix including the convolution filter weights and WT is the transpose of W, b is the bias for the convolution filter, ×_{h,w,c}^{F} denotes the sliding convolution window centered at (h, w, c) in F, X_{h,w}^{M} denotes the binary mask corresponding to the current sliding convolution window centered at (h, w) in M, ⊙ denotes element-wise multiplication, and 1 has the same shape as M but with all the elements being 1. The scaling factor sum(1)/sum(X_{h,w}^{M}) applies appropriate scaling to adjust for the varying amount of valid (unmasked) inputs. After each partial convolution operation, the mask may be updated as follows: if the convolution was able to condition its output on at least one valid input value, then that location is marked valid, which is expressed as:

$${M}_{{h}^{′} , {w}^{′}}^{′} = \{ \begin{matrix}1 , & if sum ( {X}_{h , w}^{M} ) > 0 \\ 0 , & otherwise\end{matrix}$$

In Equation [1], the mask image M has the same dimension H×W (e.g., 64×64, 32×32, 8×8) as the feature map or the input image F in one channel, with value “0” in masked area and value “1” in unmasked area. As illustrated in Equation [1], the masked area in the mask image M has no contribution to Z_{h′,w′,c′} since M_{h,w} has value “0” in the masked area. Accordingly, the masked area of the mask image M may be selected to cover the invalid pixels (e.g., background, image error, other object) in the input image to make the invalid pixels logically ignored when using the partial texture VAE, as illustrated in FIG. 14.

The mask-aware texture encoding layer (TEL) 410 in the partial texture VAE may include a learnable residual encoding layer, which may include a codebook 412 (dictionary, e.g., 64×32×1)). The feature map 408 may be reshaped to a feature map 414 (e.g., 64×(8×8)×1), which may be used as an input for the residual encoding layer. Residual vector representation 416 (e.g., 32×64×(8×8)) may be calculated by pairwise difference between the feature map 414 and the codes (e.g., 32 codes) of the codebook 412. Assignment weights 418 (e.g., 32×(8×8)×1)may be calculated based on pairwise distance between the feature map 414 and the codes of the codebook 412. The masked image 408M may be reshaped to a masked array 420M (e.g., 1×(8×8)) and used together with the assignment weights 418 to be aggregated with the residual vector representation 416 to generate feature aggregation map 422 (e.g., 32×64×(8×8)). For example, the masked area 421M in the masked array 420M may be transformed to a slice 421 (e.g., 32×64×1) in the feature aggregation map 422. The feature aggregation map 422 may be used to generate a feature map 424 (e.g., 32×64×1), which may be reshaped to a fixed-length representation 426 (e.g., 64×32×1), in which the resulting vectors may be normalized using the L2 normalization. Therefore, the TEL 410 acts as a feature aggregation module. There are several advantages in integrating this module, for example, the TEL 410 may take images with any input sizes and provide the output as a fixed-length representation, which may be spatially orderless representation, making the feature translation invariant and scale equivariant, as well as rotation invariance.

The fixed-length representation 426 may be fed into a fully connected (FC) layer to generate an updated map 428. The FC layer may multiply the input by a weight matrix and then add a bias vector. The FC layers may be used for updating weights due to its ability to introduce more connectivity possibilities, as every neuron of the FC is connected to every neuron of the previous layer. The updated map 428 may be used to generate a feature map 430 via reparameterization. The feature map 430 may then be decoded by the decoder of the partial texture VAE to generate a feature map 432 (e.g., 8×8×64), which may be used to generate a feature map 434 (e.g., 16×16×32). The feature map 434 may be used to generate a feature map 436 (e.g., 32×32×8), which may be used to generate an output image 438 (e.g., 64×64×3). The decoder may integrate up-sampling blocks followed by a convolution layer instead of a deconvolution layer (e.g., to avoid the checkerboard effects in the generated image).

FIG. 12 illustrates a process 500 for image analysis using another embodiment of a partial texture VAE, which uses a mask-aware global average pooling (GAP) 510 instead of the mask-aware TEL 410 in the encoder and uses partial convolution in the convolution layers of the encoder of the partial texture VAE. As illustrated in FIG. 12, the last feature map 408 and the last updated mask image 408M generated by the encoder of the partial texture VAE may be input into the mask-aware global average pooling (GAP) 510. During the average pooling operation in the GAP 510, only the unmasked area in the mask image may contribute to the result, as illustrated in Equation [2] below. Equation [2] describe a mask-aware global average pooling on the last feature map F ∈ R^{(H×W×C)}) (e.g., the feature map 408) to generate a global feature tensor 526:

$${Z}_{i} = [ \frac{1}{sum ( M )} {\sum }_{h = 1}^{H} {\sum }_{w = 1}^{W} {F}_{h , w , c} {M}_{h , w} ] \qquad [ 2 ]$$

Where i corresponds to c, M_{h,w} represents the value at a location on the last mask image M ∈ {0, 1}^{H×W} (e.g., the mask image 408M) with coordinate (h,w) (e.g., height h=1, 2 . . . H, width w=1, 2 . . . W), and F_{h,w,c} represents the value at a location on the last feature map F ∈ R^{(H×W×C) with coordinate (h,w,c). In Equation [}2], the mask image M has the same dimension H×W (e.g., 64×64, 32×32, 8×8) as the feature map or the input image F in one channel, with value “0” in masked area and value “1” in unmasked area. As illustrated in Equation [2], the masked area in the mask image M has no contribution to Zᵢ since M_{h,w} has value “0” in the masked area. Accordingly, the masked area of the mask image M may be selected to cover the invalid pixels (e.g., background, image error, other object) in the input image to make the invalid pixels logically ignored when using the partial texture VAE, and the pixel values of the invalid pixels may not contribute to the result of the partial texture VAE.

As illustrated in FIG. 12, the GAP 510 is used to convert the feature map 408 to an one-dimensional (1D) global feature tensor 526 based on the average response amplitude of each channel of the feature map 408. Since the mask image 408M has value “0” in the masked area, the masked area has no contribution to the tensor 526. In addition, the GAP 510 makes the feature rotation and translation invariant and scale equivariant. These aspects of the feature are important from geological point of view. Accordingly, rotated or translated versions of the image may be assigned with the same or very similar features as the original image, and re-scaled versions of the image may be assigned with different feature values (e.g., to distinguish fine sandstone and medium sandstone).

The global feature tensor 526 may be fed into a fully connected (FC) layer, which acts as a classifier to generate an updated map 528. The FC layer may multiply the input by a weight matrix and then add a bias vector. The FC layers may be used for updating weights due to its ability to introduce more connectivity possibilities, as every neuron of the FC is connected to every neuron of the previous layer. The updated map 528 may be used to generate a feature map 530 via reparameterization. The feature map 530 may then be decoded by the decoder of the partial texture VAE. For example, the feature map 530 may be decoded to generate a feature map 532 (e.g., 8×8×64), which may be used to generate a feature map 534 (e.g., 16×16×32). The feature map 534 may be used to generate a feature map 536 (e.g., 32×32×8), which may be used to generate an output image 538 (e.g., 64×64×3). The decoder may integrate up-sampling blocks followed by a convolution layer instead of a deconvolution layer (e.g., to avoid the checkerboard effects in the generated image).

FIG. 13 is a block diagram illustrating a training process 600 for a partial texture VAE 602 including a GAP layer, such as the partial texture VAE in FIG. 12. The training process 600 may be used to update the network parameters based on a loss function using training data. For instance, a set of individual cutting instance images 604 (e.g., Iᵢ ∈ R^{(Hi×Wi×3)})may be used as training images, which may be cropped to have the same size to be used as the training data for the partial texture VAE 602. For example the images 604 with Iᵢ ∈ R^{(H}^{ᵢ}^{×W}^{ᵢ}^{×3)} may be transformed to cropped images 606 with Iᵢ^{crop} ∈ R^{(H}^{_{crop}}^{×W}^{_{crop}}^{×3)}, with the cropped image dimensions H_{crop} and W_{crop} fixed to a specific value (e.g., 56, 64, 128). In some embodiments, the cropped images 606 may be the portions of the corresponding images 604 that contain no invalid pixels (e.g., background, image error, other object), and corresponding synthetic mask images 608 (e.g., Mᵢ^{crop} ∈ {0, 1}^{(H}^{_{crop}}^{×W}^{_{crop}}⁾) may be created randomly (e.g., adding number N randomly selected ellipsoidal spots), as illustrated in FIG. 13.

The cropped images 606 Iᵢ^{crop} and the mask images 608 Mᵢ^{crop} may be used as an input 610 for training the partial texture VAE 602. The partial texture VAE 602 may include an encoder 612, which may include hidden layers (e.g., convolution layers, pooling layers) using partial convolution. The encoder 612 may include a GAP layer 614, and during the average pooling operation in the GAP 612, only the unmasked area in the mask images 608 may contribute to the result, as illustrated in Equation [2] above. Features may be extracted by the encoder 612 from the cropped images 606 and generate corresponding feature maps 616, which may be decoded by a decoder 618 of the partial texture VAE 602 to generate corresponding output images 620 Iₒ^{crop}. The output images 620 Iᵢ^{crop} may have a relationship with the input 610, as described in Equation [3]:

$${\hat{I}}_{o}^{crop} = autoencoder ( {I}_{i}^{crop} , {M}_{i}^{crop} ) \qquad [ 3 ]$$

To extract textural information in the latent space, a perceptual loss may be used in the loss function for training the VAE 602 to better capture textual information (e.g., using Mean squared error (MSE) or binary cross entropy (BCE) may cause a blurred version of the input image). For instance, Øⱼ(I) may be the activation of the j-th layer of the network Ø when processing image I. The j-th layer may be a convolutional layer, so Øⱼ(I) is a feature map of shape Cⱼ×Hⱼ×Wⱼ, i.e., Øⱼ (I) ∈ R^{C}^{ⱼ}^{×H}^{ⱼ}^{×W}^{ⱼ}. The network Ø may be well-known architecture, such as VGG, AlexNet, and Squeeze Net, and pretrained with a large dataset such as ImageNet. The layer j to be used from the network Ø may be a choice of the design. The perceptual loss using j-th layer is defined in Equation [4] as:

$${L}_{recons}^{j} ( {I}_{i}^{crop} , {\hat{I}}_{o}^{crop} ) = f ( {∅}_{j} ( {I}_{i}^{crop} ) , {∅}_{j} ( {\hat{I}}_{o}^{crop} ) ) \qquad [ 4 ]$$

In Equation [4], there may be different ways to define the function ƒ, which is used to compute the loss from two feature maps, such as using the pairwise L2 distance, L2 distance of the Gram matrices, or combination of them with weight parameters. The function ƒ may also integrate cosine similarity or structural similarity (SSIM). The total reconstruction loss is the sum of the reconstruction losses from all the target layers, as illustrated in Equation [5]:.

$${L}_{recons} = {\sum }_{j}^{} {L}_{recons}^{j} ( {I}_{i}^{crop} , {\hat{I}}_{o}^{crop} ) \qquad [ 5 ]$$

In addition, Kullback-Leibler (KL) divergence loss (e.g., L_{KLD} DKL(q(z|I∥p(z))) may be used during the training process to control the distribution of the latent vector z, which is independent Gaussian random variables (e.g., random variables with a unit variance and zero mean). The final loss may be expressed as in Equation [6]:

$${L}_{total} = {L}_{recons} + β {L}_{KLD} , \qquad [ 6 ]$$

where β is a weighting parameter. The value of β may be selected so that both L_{recons} and L_{KLD} smoothly decrease during training.

FIG. 14 is a block diagram illustrating a feature extraction process 700 to extract features from analyzing images 702 by using the encoder 612 after the partial texture VAE 602 is trained. For instance, an input image 704 Iᵢ ∈ R^{(H}^{ᵢ}^{×W}^{ᵢ}^{×3)} may be selected from the analyzing images 702, and corresponding mask image 706 Mᵢ ∈ {0, 1}Hi×Wi may be used as an input 708 for inputting into the encoder 612 to extract D-dimensional feature vector vᵢ ∈ R^{D} included in the feature map 710. The mask image 706 may be obtained from instance segmentation computation (e.g., via the cutting instances segmentation module 112) or generated by checking specific pixel values (e.g., (255, 255, 255)) in the image 704, which may correspond to the background (e.g., the sample tray) used during the image acquisition 96, when taking an image of the cuttings 46. In some embodiments, The mask image 706 (e.g., dark area corresponding to the foreground and while area corresponding to the background of the images 704) may be any shape corresponding to a corresponding part of the image 704 (e.g., background, image error, other object, a certain area), and the mask image 706 may be used in the encoder 612 to logically ignore the corresponding part of the images 704 (e.g., for image inpainting) by using the partial convolution operation.

In the illustrated embodiment in FIG. 14, the input images may not be cropped since the GAP layer 614 is trained. The invalid pixels (e.g., background, image error, other object) in the input image 704 are logically ignored due to the use of partial convolution as described above. The feature vector vᵢ may be expressed in Equation [7]:

$${v}_{i} = Encocer ( {I}_{i} , {M}_{i} ) \qquad [ 7 ]$$

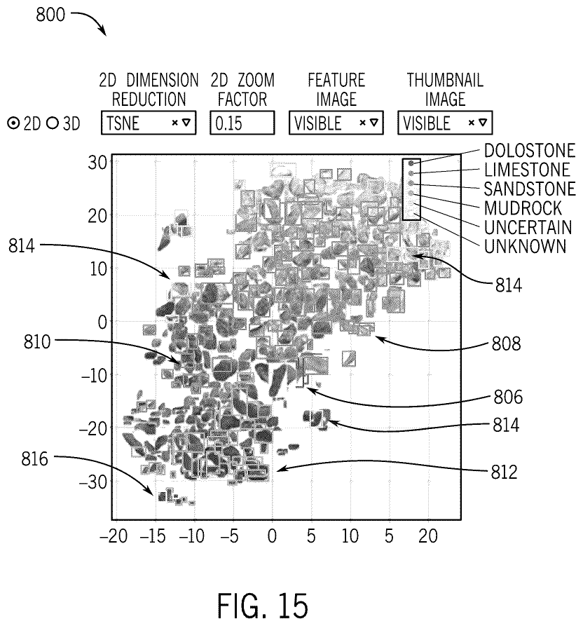

The extracted features may be used in different ways, such as classification, clustering, information retrieval, visualization, etc. The features may be used as input of a lithology classification and similarity-based property extraction. The classification may be parametric (requires training) or non-parametric (does not require training). The extracted features may also be used as inputs of clustering of the cuttings instance images. Most similar cuttings may be retrieved based on the distance between feature vectors. For example, the smaller the distance between two feature vectors of two images, the more similar the two images are. Dimensions of the feature maps may be modified (e.g., reduced) using technique such as PCA and t-SNE, and the feature maps may be plotted in 2D or 3D map. In visualizations, visually similar cuttings may be placed in the same area. The visual distribution helps interpretation of the rock type groups. FIG. 15 shows a visualization 800 of the rock cuttings. The cutting images projected in the 2D or 3D space after reducing the dimension from the original D-dimensional feature space using projection techniques such as t-SNE (t-distributed stochastic neighbor embedding) or PCA (principal component analysis) may be displayed. The color and patterns used in the display 800 may be lithological patterns of the user company's standard or based on the USGS (United States Geological Survey) standard. The property description of the cuttings may show the distributions of the lithology types (e.g., dolostone 806, limestone 808, sandstone 810, mudrock 812, uncertain category 814, unknown category 816).

The techniques and system disclosed herein relate to analyzing rock cuttings and measure physical lithological features of the rock cuttings. Systems and methods are provided to extract features (e.g., colors, textual features) from arbitrary shaped and sized images containing invalid pixels (e.g., background, image error, other object) by implementing global average pooling (GAP) and partial convolution in an autoencoder (AE) for analysis of the images. It should be noted that, the feature extraction technique described herein may be applied to other images (e.g., rock core images, borehole images) and/or images in any domain, such as remote sensing and medical imaging. In some embodiments, an autoencoder (AE), which may be data driven and/or unsupervised, may be used to extract texture features from images. In some embodiments, a variational autoencoder (VAE) may be used to control the distribution of the latent space. In some embodiments, a vanilla AE may be used instead of VAE. A global average pooling (GAP) layer may be used at the last layer of the encoder to make the feature rotation and translation invariant and scale equivariant. In addition, partial convolution may be used in the encoder to logically ignore the invalid pixels (e.g., background, image error, other object) in the images. It should be noted that, in some embodiments, the system and methods described herein may be used for excluding any pixel (e.g., in any area of the input image) from the feature extraction process for imaging processing purposes, such as image inpainting, etc. An image analysis workflow is provided, which includes multiple computational modules to automatically extract relevant geological information from rock cuttings. Reference data, manual descriptions, and well log values are associated and used to determine rock properties of the rock cuttings. A software is developed for the image analysis, and results are displayed in various views. The results may be used to control related devices, such as the drilling system 10 and/or drilling plans of the drilling system 10 based on the rock properties (e.g., lithology) of the rock cuttings. For example, the analysis and control system 50 may automatically adjust one or more operating parameters of the drilling system 10 from which the rock cuttings are obtained based at least in part on the determined rock properties of the rock cuttings. The techniques and method disclosed herein may allow the acquisition of high quality logging curves for real-time and/or near real-time geologic formation evaluation and geosteering, which may be used to control the drilling process more efficiently and accurately. Although the examples described above are illustrated for wellbores on the land, similar method may be applied to any acquisition configuration. In addition, in the illustrated embodiments above, the techniques and systems are primarily described in the context of digital images having three color channels (e.g., R, G, B). However, the techniques and systems described above may be applied to other types of digital images, such as grayscale images, hyperspectral images, multispectral images, etc.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

In the claims, means-plus-function clauses are intended to cover the structures described herein as performing the recited function and not only structural equivalents, but also equivalent structures. Thus, for example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

1. A method, comprising:
receiving, via an encoder, an image;
generating, via the encoder, a feature map by performing a partial convolution operation using the image and a mask image for the image;
generating, via the encoder, an updated mask image based on the mask image and a dimension of the feature map;
performing, via the encoder, a global average pooling (GAP) operation on the feature map using the updated mask image to generate a global feature map; and
generating, via the encoder, an output feature vector for the image based on the global feature map.

2. The method of claim 1, wherein the encoder is a part of a variational autoencoder (VAE).

3. The method of claim 1, comprising:
generating the mask image for the image by detecting a specific pixel value in the image.

4. The method of claim 1, wherein the mask image comprises a binary image.

5. The method of claim 4, wherein the binary image comprises a first portion corresponding to invalid pixels of the image corresponding to pixel values equal to 0.

6. The method of claim 5, wherein the binary image comprises a second portion corresponding to valid pixels of the image corresponding to pixel values equal to 1.

7. The method of claim 1, wherein the image and the mask image have a same dimension.

8. The method of claim 1, wherein the global feature map comprises a one-dimensional (1D) tensor generated based on an average response amplitude of each channel of the feature map.

9. The method of claim 8, wherein the feature map comprises a plurality of channels, and each value of the 1D tensor is determined based on the updated mask image and a respective channel of the plurality of channels.

10. The method of claim 1, wherein the image comprises a cutting instance image of a cutting of a geological formation, and wherein the output feature vector comprises a rock property of the cutting.

11. The method of claim 10, wherein the rock property comprises textual information.

12. The method of claim 10, wherein the rock property comprises color information.

13. A method of training an autoencoder (AE), comprising:
generating a set of training images from a plurality of images;
generating respective mask images for the set of training images;
inputting the set of training images and the respective mask images into an encoder of the AE, wherein the encoder is configured to:
generating respective feature maps for the set of training images by performing partial convolution operation using the training images and the respective mask images; and
generating respective global feature maps by performing a global average pooling (GAP) operation on the respective feature maps;
generating, via a decoder of the AE, respective output images for the set of training images based on the respective global feature maps; and
training the AE using the respective output images and the training images based on a loss function.

14. The method of claim 13, wherein the set of training images and the respective mask images have a same dimension.

15. The method of claim 13, comprising:
generating the respective mask images for the set of training images randomly.

16. The method of claim 13, wherein the loss function comprises a perceptual loss function for extracting textual information from the set of training images.

17. The method of claim 13, wherein the plurality of images comprise cutting instance images of a cutting of a geological formation.

18. An autoencoder (AE), comprising:
an encoder, comprising:
a convolution layer configured to generated a feature map by performing a partial convolution operation using an image and a mask image for the image; and
a global average pooling (GAP) layer configured to generate a global feature map by performing a GAP operation on the feature map using an updated mask image generated based on the mask image; and
a decoder configured to generate an output image based on the global feature map.

19. The AE of claim 18, wherein the mask image comprises a binary image.

20. The AE of claim 19, wherein the binary image comprises a first portion corresponding to invalid pixels of the image corresponding to pixel values equal to 0.

21. The AE of claim 20, wherein the binary image comprises a second portion corresponding to valid pixels of the image corresponding to pixel values equal to 1.

22. The AE of claim 18, wherein the GAP layer is configured to generate the global feature map with feature rotation and translation invariant and scale equivariant.

23. The AE of claim 18, wherein the image comprises a cutting instance image of a cutting of a geological formation.
